(19) United States
(12) Patent Application Publication
(10) Pub. No.: US 2006/0062264 A1
(43) Pub. Date: Mar. 23, 2006

(54) Optical module

(75) Inventor: Shosuke Miyaki, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 11/202,265

(22) Filed: Aug. 12, 2005

(30) Foreign Application Priority Data
Sep. 17, 2004 (JP) 2004-270898

(51) Int. Cl. H01S 3/04

(52) U.S. Cl. 372/34

(57) ABSTRACT

An optical module that operates stably against temperature changes even in the form of package. The optical module having a semiconductor laser housed in a case, the case being cooled by a cooler made of a Peltier device, wherein a heat sink is attached to the cooler movably relative to the case through a half-solid-like heat conduction component.

### BACKGROUND OF THE INVENTION

1. Field of Invention

The present invention relates to an optical module, and more particularly to an improvement in temperature characteristics of an optical module such as a wavelength tunable light source for use in, for example, an optical measuring device.

2. Description of the Prior Art

In general, a preferable light source for use in an optical measuring device is a wavelength tunable light source capable of emitting a light of an arbitrary wavelength, because the optical measuring device often measures wavelength characteristics of various optical device modules including a light receiving element, a filter, a beam splitter, and a grating or of an optical device made of these various optical elements combined.

On the other hand, from the aspects of downsizing or portability of the optical measuring device containing the light source, it is desired to downsize a light source module.

As one of the wavelength tunable light sources, there is a light source housed in a case and integrated therein as an optical module of an external cavity control semiconductor laser, in such a way that a light emitted from a semiconductor laser is incident on a wavelength selecting section made of gratings and mirrors, only a light of a selected wavelength is returned to the semiconductor laser, and the semiconductor laser oscillates at the wavelength selected by the wavelength selecting section.

The semiconductor laser housed in the case is susceptible to thermal expansion or contraction caused by a temperature change in the housing case and therefore a significant temperature change disables the semiconductor laser from generating stable optical power.

Therefore, in the field of the optical module including a semiconductor laser as an element, there has been suggested an arrangement wherein a cooler made of a Peltier device is attached to the outside of the base plate of a package corresponding to the housing case to reduce the temperature distribution of the entire package, thus preventing a deformation of the package and minimizing fluctuations of the optical power caused by temperature changes, as has been disclosed in Japanese Laid-Open Patent Publication (Kokai) No. 2004-014840, for example.

In packaging of the optical module having the cooler made of the Peltier device for cooling, however, a plurality of components need be attached to the module besides the housing case. In the attachment of these components, there is a need for consideration to prevent a mechanical load caused by an effect of a thermal expansion or contraction on the housing case due to temperature changes in the plurality of components.

While Japanese Laid-Open Patent Publication (Kokai) No. 2004-014840 discloses the arrangement for cooling the package, however, it does not describe a concrete arrangement for preventing the mechanical load caused by the effect of the thermal expansion or contraction on the housing case due to temperature changes in the plurality of components as described in the present invention.

In view of the above problem, the present invention has been provided. Therefore, it is an object of the present invention to provide an optical module that operates stably against temperature changes even in the form of package.

### SUMMARY OF THE INVENTION

According to a first aspect of the present invention that achieves the above object, there is provided an optical module having a semiconductor laser as an element housed in a case, the case being cooled by a cooler made of a Peltier device, wherein a heat sink is attached to the cooler movably relative to the case through a half-solid-like heat conduction component.

According to a second aspect of the present invention, there is provided an optical module having a semiconductor laser as an element housed in a case, the case being cooled by a cooler made of a Peltier device, and having a printed circuit board for supplying electric signals to the semiconductor laser and the Peltier device on the underside of the case, wherein the printed circuit board is attached to the case through flexible attachment components.

According to a third aspect of the present invention, there is provided an optical module having a semiconductor laser as an element housed in case, the optical module comprising: a board-like heat conduction component attached to the undersurface of the case through a half-solid-like heat conduction component; a cooler made of a Peltier device with the field which absorbs heat thereof superposed on the board-like heat conduction component through a half-solid-like heat conduction component; a heat sink superposed on the field which emits heat of the cooler through a half-solid-like heat conduction component and attached to the board-like heat conduction component through a heat insulation component; and a printed circuit board for supplying electric signals at least to the semiconductor laser and the Peltier device, the printed circuit board being located between the board-like heat conduction component and the heat sink and attached to the case through flexible attachment components.

### BRIEF DESCRIPTION OF THE DRAWINGS

FIG. 1 is a partial cross-sectional configuration diagram showing an embodiment of an optical module according to the present invention.

### DETAILED DESCRIPTION OF THE INVENTION

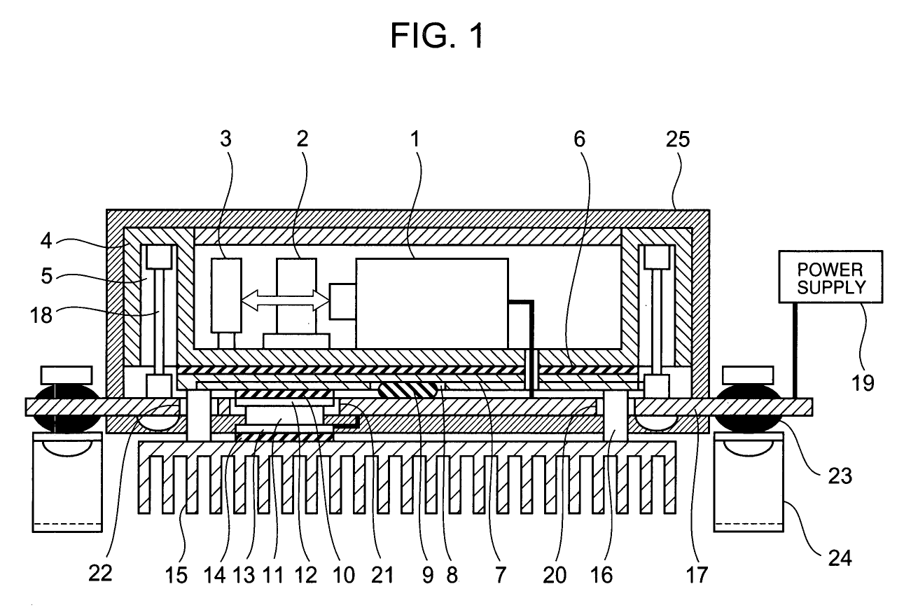

The present invention will now be described in detail hereinafter with reference to the accompanying drawing. Referring to FIG. 1, there is shown a partial cross-sectional configuration diagram showing an embodiment of an optical module according to the present invention. In FIG. 1, a semiconductor laser 1 is housed in a case 4 with a cover, along with gratings 2 and mirrors 3. The semiconductor laser 1, the gratings 2, and the mirrors 3 form an optical module of an external cavity control semiconductor laser, in such a way that a light emitted from the semiconductor laser 1 is incident on a wavelength selecting section made of the gratings 2 and the mirrors 3, only a light of a selected wavelength is returned to the semiconductor laser 1, and the semiconductor laser 1 oscillates at the wavelength selected by the wavelength selecting section, as stated above. The mirrors 3 are rotatably attached.

The case 4 is molded in one piece in substantially into a rectangular box by casting or machining, for example, with attachment holes 5 made by counterboring at the four corners of the case 4. A board-like heat conduction component 7 typified, for example, by a copper plate is attached to the undersurface of the case 4 through a half-solid-like heat conduction component 6 typified, for example, by silicon grease. A dented portion 8 is provided on one side of the board-like heat conduction component 7, with an O-ring 9 as a shock absorbing material disposed in the dented portion 8 so as to fit therein.

The field which absorbs heat 12 of a cooler made of a Peltier device 11 is superposed on the board-like heat conduction component 7 through a half-solid-like heat conduction component 10. An attachment face of a heat sink 15 is superposed on the field which emits heat 13 of the cooler through a half-solid-like heat conduction component 14. The attachment face of the heat sink 15 is attached to the board-like heat conduction component 7 through attachment components 16 of heat insulation components made of, for example, polyacetal.

A printed circuit board 17 is disposed between the board-like heat conduction component 7 and the heat sink 15 in such a way as to press the O-ring 9. The printed circuit board 17 is attached to the underside of the attachment holes 5 of the case 4 through attachment components 18 each having a constriction thinner than both ends thereof in the middle in such a way as to gain flexibility. In the case of a difference in thermal expansion or contraction due to a temperature change between the case 4 and the printed circuit board 17, the constriction bends to absorb a mechanical displacement between them and thus prevents a mechanical load caused by an effect of the thermal expansion or contraction on the case 4 due to the temperature change.

The printed circuit board 17 is provided with a wiring pattern, which is not shown, for use in supplying electric signals to at least the semiconductor laser and the Peltier device, with the wiring pattern connected to a power supply 19.

Furthermore, the printed circuit board 17 is provided with a plurality of through holes 20 to 22 for use in passing the cooler made of the Peltier device 11 and the attachment components 16 through these holes with enough play in their outer regions.

Still further, the printed circuit board 17 is formed in a larger size than the undersurface of the case 4, with the portions extending from the bottom edges of the case 4 fixed to attachment angles 24 through shock absorbing materials 23 like rubber bushes. These attachment angles 24 can also be used as attachment members to place the optical module at a given location of a measuring device, if necessary.

Moreover, a heat insulation component 25 is pasted on the outer surface of the case 4 and the undersurface of the printed circuit board 17 so as to insulate them from an external atmosphere.

The following describes an assembly process of the optical module configured as stated above.

First, the semiconductor laser 1, the gratings 2, and the mirrors 3 are incorporated into the case 4 to form the optical module of the external cavity control semiconductor laser.

The half-solid-like heat conduction component 6 is then applied to the board-like heat conduction component 7 and thereafter the board-like heat conduction component 7 is attached to the undersurface of the case 4 through the heat conduction component 6.

Thereafter, the O-ring 9 is fitted into the dented portion 8 provided on one side of the board-like heat conduction component 7 and then the printed circuit board 17 is attached and fixed at the attachment holes 5 of the case 4 through the attachment components 18.

Subsequently, the heat conduction component 10 is applied to the field which absorbs heat 12 of the cooler made of the Peltier device 11, and then the cooler is attached in the field which absorbs heat 12 to the board-like heat conduction component 7 through the heat conduction component 10. Then, the printed circuit board 17 is connected to the above parts for the supply of electric signals.

Thereafter, the heat insulation component 25 is pasted on the outer surface of the case 4 and the undersurface of the printed circuit board 17.

Subsequently, the heat conduction component 14 is applied to the field which emits heat 13 of the cooler and then an attachment surface of the heat sink 15 is put on the field which emits heat 13 through the heat conduction component 14. The heat sink 15 is then fixed to the board-like heat conduction component 7 through the attachment components 16.

Portions extending from the bottom edges of the case 4 of the printed circuit board 17 are fixed to the attachment angles 24 through the shock absorbing materials 23.

In this configuration, the board-like heat conduction component 7 functions in such a way as to diffuse the cooling air of the cooler to achieve an even distribution of temperature all over the undersurface of the case 4 through the heat conduction component 6.

In the case of a temperature difference between the undersurface of the case 4 and the board-like heat conduction component 7, the half-solid-like heat conduction component 6 functions in such a way as to cause the board-like heat conduction component 7 to slide on the undersurface of the case 4 and thus prevents the case 4 from being affected by a mechanical displacement caused by a thermal expansion or contraction due to the temperature change.

In the case of a temperature difference between the field which absorbs heat 12 of the cooler made of the Peltier device 11 and the board-like heat conduction component 7, the half-solid-like heat conduction component 10 functions in such a way as to cause the board-like heat conduction component 7 to slide on the field which absorbs heat 12 of the cooler and thus prevents the field which absorbs heat 12 of the cooler from being affected by a mechanical displacement caused by a thermal expansion or contraction due to the temperature change.

In the case of a temperature difference between the field which emits heat 13 of the cooler made of the Peltier device 11 and the attachment surface of the heat sink 15, the half-solid-like heat conduction component 14 functions in such a way as to cause the attachment surface of the heat sink 15 to slide on the field which emits heat 13 of the cooler and thus prevents the field which emits heat 13 of the cooler from being affected by a mechanical displacement caused by a thermal expansion or contraction due to the temperature change.

The attachment component 16 made of the heat insulation component functions in such a way as to thermally insulate the heat sink 15 from the board-like heat conduction component 7 while fixing the heat sink 15 to the board-like heat conduction component 7.

The attachment components 18 each having a constriction fix the printed circuit board 17 to the case 4. In the case of a difference in thermal expansion due to a temperature change between the case 4 and the printed circuit board 17, the attachment components 18 bend to absorb a mechanical displacement between them and thus prevent a mechanical load caused by the effect of the thermal expansion on the case 4 due to the temperature change.

The shock absorbing material 23 functions in such a way as to prevent an external force applied to the attachment angles 24 from being directly transferred to the printed circuit board 17 and adversely affecting the operation of the optical module.

While the present invention has been described in connection with the above embodiment where the optical module is an external cavity control semiconductor laser for causing the semiconductor laser to oscillate at the wavelength selected by the wavelength selecting section, it is not limited to the embodiment. It is useful as measures against temperature changes in the optical module comprising at least a semiconductor laser housed in a case.

As set forth hereinabove, according to the present invention, even if there is a temperature difference between the case and the printed circuit board, the case is not affected by a thermal expansion or contraction caused by the temperature change, thus preventing a mechanical load. Thereby, it is possible to achieve an optical module that operates stably against temperature changes even in the form of package.

What is claimed is:

1. An optical module having a semiconductor laser as an element housed in a case, the case being cooled by a cooler made of a Peltier device,
wherein a heat sink is attached to the cooler movably relative to the case through a half-solid-like heat conduction component.

2. An optical module having a semiconductor laser as an element housed in a case, the case being cooled by a cooler made of a Peltier device, and having a printed circuit board for supplying electric signals to the semiconductor laser and the Peltier device on the underside of the case,
wherein the printed circuit board is attached to the case through flexible attachment components.

3. An optical module having a semiconductor laser as an element housed in case, the optical module comprising:
a board-like heat conduction component attached to the undersurface of the case through a half-solid-like heat conduction component;
a cooler made of a Peltier device with the field which absorbs heat thereof superposed on the board-like heat conduction component through a half-solid-like heat conduction component;
a heat sink superposed on the field which emits heat of the cooler through a half-solid-like heat conduction component and attached to the board-like heat conduction component through a heat insulation component; and
a printed circuit board for supplying electric signals at least to the semiconductor laser and the Peltier device, the printed circuit board being located between the board-like heat conduction component and the heat sink and attached to the case through flexible attachment components.
